(19) United States
(12) Patent Application Publication
(10) Pub. No.: US 2014/0330720 A1
(43) Pub. Date: Nov. 6, 2014

(54) System to utilize telecommunications data to authorize and activate equipment

(71) Applicant: Jared Wesley Tomlin, Normal, IL (US)

(72) Inventor: Jared Wesley Tomlin, Normal, IL (US)

(21) Appl. No.: 13/886,264

(22) Filed: May 2, 2013

(51) Int. Cl. G06Q 20/32; H04W 4/24; H04W 4/12

(52) U.S. Cl. CPC G06Q 20/3255; H04W 4/12; H04W 4/24
USPC 705/44; 455/418; 455/411

(57) ABSTRACT

This system enables equipment that previously has been activated by coin, bill, token, payment cards, etc to be activated from a telecommunications device, which will typically but not necessarily be mobile. The system maintains a database of registered users, their payment mode, prepaid or paid at time of service, account balance and allowed commands. The system is able to recognize when a message has been received from an authorized user and respond to that message with a return message as well as activating the equipment if appropriate and debiting the user's account or triggering an electronic payment in some cases. This system has a wide range of applications including but not limited to car washes, laundry machines, parking meters, vending machines, arcade games any equipment that is activated by payment or human attendant currently or which could benefit from the use of a remote activation capability.

### CROSS-REFERENCE TO RELATED APPLICATIONS

This application claims priority to and incorporates by reference U.S. Provisional Patent Application No. 61/645,456 filed May 10, 2013.

### BACKGROUND OF THE INVENTION

It is becoming increasingly common for people to have a mobile telecommunications device available. This invention utilizes data transmitted by telecommunications devices as a means of determining authorization to activate various types of equipment and it facilitates the activation of said equipment if the authorization criterion has been met. A common use of this invention would be to activate a machine that may otherwise be authorized and activated via a payment acceptor such as a coin, bill or credit card acceptor. These prior authorization methods require the user to carry a physical form of payment with them in order to use the equipment. This invention allows people to use the communication device that they have instead of these prior methods of payment and activation. As an example this invention could be used to activate car washes, laundry machines, vending machines, parking meters, and many other types of equipment without the need for the end user to carry cash, coin or payment cards.

### BRIEF SUMMARY OF THE INVENTION

This system provides a means of using telecommunications services and computer software to authorize and activate equipment. This provides an alternative to authorize and activate equipment traditionally activated by bill acceptors, coin and token acceptors, credit and debit card readers or human attendants. A typical use of this system would be to activate equipment such as a car wash, laundry machine, food or beverage dispenser and many other devices that traditionally use other forms of authorization and activation. One benefit to this system is the ability to operate a device that requires authorization and payment without the need for collection of a physical form of payment such as bills, coins, tokens, certificates all of which can present security and theft considerations for the operator of the equipment.

Traditional payment and activation systems often involve the physical exchange of funds between the end user and the machinery. Traditional payment systems also are typically installed on each piece of equipment at a facility such as a car wash or coin laundry facility.

This system can be wired to hundreds of pieces of equipment at a facility and activate them remotely. The system itself can also be kept in a location that is not accessible by end users. This eliminates the installation and maintenance of all of the traditional payment collection systems. It also eliminates the opportunity for theft of the money that the traditional payment systems collect and store.

### BRIEF DESCRIPTION OF THE DRAWINGS

FIG. 1 depicts the overall architecture and flow of information between the essential components of this system.

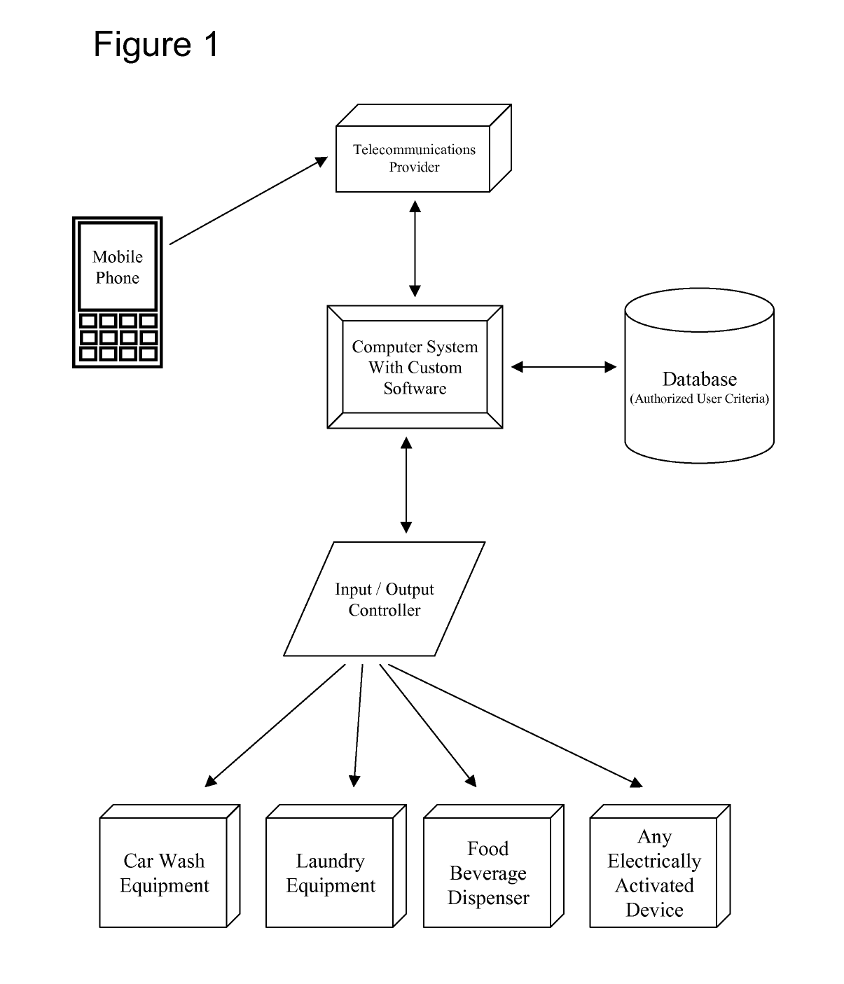

### DETAILED DESCRIPTION

This system provides a means of using telecommunications services and computer software to authorize and activate equipment. This provides an alternative to authorize and activate equipment traditionally activated by bill acceptors, coin and token acceptors, credit and debit card readers or human attendants. A typical use of this system would be to activate equipment such as a car wash, laundry machine, food or beverage dispenser and many other devices that traditionally use other forms of authorization and activation. One benefit to this system is the ability to operate a device that requires authorization and payment without the need for collection of a physical form of payment such as bills, coins, tokens, certificates all of which can present security and theft considerations for the operator of the equipment. The invention claimed here solves this problem. Another benefit of this system is that it automatically builds a database of customer names and phone numbers to allow additional marketing opportunities. Facilities using self serve coin, bill or payment card activation often have no information about the customers who have used their facility leaving them no way to market future offers to their prior customers.

This system allows an end user to initiate a communication from a telecommunications device such as a mobile phone to a phone number belonging to the system's owner/operator and provided by the telecommunications provider. The end user can do this with a text message or phone call. Using pre-configured criteria along with the electronic data from the communication that was received the system is able to determine what the end user wishes to do. For instance which machine they would like to activate. The system also determines whether or not they have authorization to take this action. The system will activate the machine or equipment for the end user if the user meets the authorization criteria as established by the system's operator. In this manner the end user is able to gain access to the machine or equipment that they wish to use without the need to provide a traditional form of payment such as: bills, coins, tokens, checks, credit cards, or debit cards.

The claimed invention differs from what currently exists. This system makes use of communications from a telecommunications device to replace the need to insert a traditional form of payment into a machine.

This invention is an improvement on what currently exists. This system makes use of communications from a telecommunications device to replace the need to insert a traditional form of payment into a machine.

Placing a traditional payment device on each piece of equipment at a facility or business increases installation and operation costs, maintenance activities, and presents an opportunity for theft or vandalism to occur.

This system can be wired to hundreds of pieces of equipment at a facility in order to activate them remotely. The system itself can also be kept in a safe location not accessible by end users. This eliminates the installation and maintenance of all of the traditional payment collection systems as well as the opportunity for theft of the money that they collect.

The version of the invention discussed here includes:
1. Telecommunications device
2. Telecommunications service provider
3. Computer system
4. Custom software
5. Database
6. Graphical user interface
7. Computer controlled input/output controller
8. Equipment to be activated

### Relationship Between the Components

A message or communication is initiated from a telecommunications device (1). The message is received by a phone number provided by the operator's telecommunications provider (2). The electronic data packet from the telecommunications provider is sent to the computer system (3). Custom software (4) on the computer system (3) processes the data packet and compares it to criteria stored in a database (5). The operator configures the authorization and activation criteria ahead of time using a Graphical User Interface (6) which is part of the Custom Software (4). If the data packet contains data matching a configured activation event as stored in the database (5) and the sender of the message is authorized based on criteria stored in the database (5) the software (4) will send an activation command to the computer controlled input/output controller (7). The custom software (4) may also check the state of an input on the computer controlled input/output controller (7) to determine whether or not to proceed with the activation. This input verification is also configured via the custom software (4) and the configuration is stored in the database (5). Once the custom software (4) sends the activation signal to the input/output controller (7) the input/output controller activates an electrical output which is wired to the desired equipment to be activated (8). Once the equipment (8) has been activated the custom software (4) will send a message back to the sender's telecommunication device (1) by way of the telecommunications provider (2). This message can be a text message or audible message. The database (5) is updated to record the details of the communications that took place and the actions that the system performed.

The system works by using data in the data packet transmitted by the telecommunications provider to determine the phone number of the sender and the content of their message or their key press response in the event of a touch tone interaction. The message content or key press is compared to a user configurable list of command messages and actions. The system uses common programming techniques to match the message content or key press to one of the pre-configured commands. Once the command is known the system checks the authorization requirements, which are included in the database record for that command. A common authorization requirement is a user account balance above the cost of this command and optionally a criteria that the user be part of a group of users authorized to use this command. If the criteria are met the system can update the user's account information in the database and proceed with activation of a relay on the input/output controller which in turn causes the desired equipment to activate. The users 10 digit phone number is included in the data packets from the telecommunications provider. This 10 digit value is used to uniquely identify the user in the database and also to store and record their account balances and activity. Each time an activation is successfully performed by the system in response to a command initiated by the user the system updates the user's account balance based on the criteria for that command. In other words commands can be configured to have a cost and this cost is deducted from the account of the user who sent the command. Activating the equipment is accomplished by means of a computer controlled input/output controller. There are many available input/output controllers available and this system can be adapted to work with any of them so a detailed explanation of their operation is not provided here other than to say that the system can check the state of the inputs and outputs and compare them to the configured criteria to determine if it is o.k. to proceed with a specific command. If the input/output status is acceptable based on the configured criteria the system will signal the controller to activate the desired output or multiple outputs. The system also provides a means of recording the number and length of the output activation for a given command. For example a command could be configured to result in activating a specific output 12 times for a given duration in order to allow that output to be wired to a traditionally coin operated machine such that the 12 activations simulate for the connected device 12 coins being deposited. Communication back to the end user is accomplished through the telecommunication provider's API or application programming interface. The API allows the software to communicate to the message provider the recipient and the message, which can then be delivered by the telecommunications provider via text message or audible phone response. The system also provides APIs of its own to allow accounts to be updated from an internet site or through web services such that customers can purchase accounts or add to their accounts via the internet if desired. The system operator is also provided graphical interface tools that allow them to create accounts for new customers, add funds to accounts, configure system responses, view operational and account history and monitor incoming and outgoing messages.

Equipment that needs to be controlled by this system should be wired to the input output controller to produce the desired activation results when a relay on the controller is activated or an input is read by the system. This typically means wiring the controller to the equipment in the same way that the traditional payment acceptance device would have been wired. Customer accounts should be added to the system using the graphical user interface or via an internet based form that makes use of the system application programming interfaces to create customer accounts. Commands need to be configured so that the system knows which inputs and outputs to interact with when the command is sent by a customer.

In addition to using this system to activate equipment that is normally activated by way of a traditional payment method this system can also be used to activate equipment that would not typically be payment activated. This would provide a convenient and remote ability to activate any type of equipment that can be activated by an electrical relay.

1. A method for activating equipment after authentication and validation of data received from a telecommunications system.

2. The method of claim 1 further comprising the ability to perform the equipment activation in response to telecommunications data which resulted from the receipt of an Short Message Service (SMS) text message by the telecommunications provider.

3. The method of claim 1 further comprising the ability to perform the equipment activation in response to telecommunications data which resulted from the receipt of a phone call also incorporating touch tone response data by the telecommunications provider.

4. The method of claim 1 further comprising the ability to store a list of authorized users and authenticate received data against this list to determine whether or not equipment activation should occur.

5. The method of claim 1 further comprising the ability to manage account credit on a per user basis so that equipment activation occurs only when a user has been authenticated and also has sufficient credit in their account to activate the equipment.

6. The method of claim 1 further comprising the ability to charge customers at the time of activation via integration with payment processing gateways.

7. The method of claim 1 further comprising the ability to configure the list of valid message data that the system will respond to as well as the input/output controller response that will occur for each valid message.
